(19) United States
(12) Patent Application Publication
(10) Pub. No.: US 2026/0213407 A1
(43) Pub. Date: Jul. 23, 2026

(54) METASURFACES BASED ON INTEGRATED FERROELECTRIC DEVICES FOR PHASE CONTROL WITH ENHANCED OPTICAL TRANSPARENCY

(71) Applicant: Dell Products L.P., Round Rock, TX (US)

(72) Inventors: Tejinder Singh, San Jose, CA (US); Navjot Kaur Khaira, San Jose, CA (US); Hrishit Mohan Das, Ottawa (CA); David F. Hardy, Ottawa (CA); Shulabh Gupta, Ottawa (CA)

(21) Appl. No.: 19/277,329

(22) Filed: Jul. 22, 2025

Related U.S. Application Data
(60) Provisional application No. 63/747,208, filed on Jan. 20, 2025.

(51) Int. Cl. H01Q 3/36; H01Q 1/48; H01Q 19/06

(52) U.S. Cl. CPC H01Q 3/36; H01Q 1/48; H01Q 19/067

(57) ABSTRACT

The technology described herein is generally directed towards an electronically tunable unit cell integrated with ferroelectric (e.g., Barium Strontium Titanate (BST)) thin film for phase control, such as for use in a metasurface to controllably redirect beamformed signals in the millimeter wave (mm-wave) band and higher. By controllably varying the relative permittivity of the BST layer, a sufficient reflection phase variation can be achieved with sufficiently low reflection losses. In one implementation, the metasurface can be highly optically transparent, based on the small dimensions of the unit cells'resonating elements that include the ferroelectric material, an optically transparent substrate, and a substantially optically transparent mesh ground plane, whereby, for example, the metasurface can be integrated in glass panels, and used in holographic applications. Evaluation results indicate suitability of the metasurface in mm-wave communications. The ferroelectric materials can be monolithically integrated into metasurface unit cells using microfabrication clean-room processes.

### RELATED APPLICATION

The subject patent application claims priority to U.S. Provisional Patent Application Ser. No. 63/747,208, filed Jan. 20, 2025, and entitled “HOLOGRAPHIC METASURFACES BASED ON INTEGRATED FERROELECTRIC DEVICES FOR PHASE CONTROL WITH ENHANCED OPTICAL TRANSPARENCY” (docket no. 142235.01/DELLP1496US), the entirety of which patent application is hereby incorporated by reference herein.

### BACKGROUND

Signals in the millimeter wave (mm-wave, e.g., Ka, V, and W) frequency bands and higher experience high attenuation (significant blockage) through materials commonly found in cities or indoor environments. Such attenuation poses a challenge in deploying reliable and high throughput mm-wave communication networks.

Technologies generally known as metasurfaces (or reflectarrays or reconfigurable intelligent surfaces) can be developed to mitigate blockage issues by redirecting signals around obstacles, thus maintaining a virtual line of sight between a signal source and signal receiver. In general, a metasurface is composed of unit cells, which are two-dimensional arrays of sub-wavelength scattering elements often integrated with actively biased components. The actively biased components facilitate dynamic control to manipulate the response of electromagnetic (EM) radiation. By controlling the unit cells via biasing, a metasurface can focus, block, or steer the main lobe of the scattered EM field towards the target by controlling the reflectance or transmittance magnitude and phase.

### BRIEF DESCRIPTION OF THE DRAWINGS

FIG. 1 is a top-view representation of an example metasurface (unit cell array) including a first zoomed-in portion thereof showing unit cells, and a second zoomed-in portion showing an example unit cell with varactor diodes zoomed in to show details, in accordance with various example embodiments and implementations of the subject disclosure.

FIG. 2 is a top view representation of an example unit cell (UC) along with various zoomed-in views of varactor diodes and example dimensions, in accordance with various example embodiments and implementations of the subject disclosure.

FIG. 3A is a top view representation of an example ferroelectric-based varactor diode, in accordance with various example embodiments and implementations of the subject disclosure.

FIG. 3B is a cross-sectional view representation of an example ferroelectric-based varactor diode showing example design dimensions, in accordance with various example embodiments and implementations of the subject disclosure.

FIG. 4 is a three-dimensional isometric view of an example optically transparent unit cell configuration including a hexagonally-shaped metallic resonating element on a substrate above a mesh ground plane, in accordance with various example embodiments and implementations of the subject disclosure.

FIG. 5 is a top view representation of an example unit cell along with varactor diodes showing unit cell size dimensions, in accordance with various example embodiments and implementations of the subject disclosure.

FIG. 6 is a top view representation of an example metallic ground plane portion with openings arranged in a uniform honeycomb-like pattern, in accordance with various example embodiments and implementations of the subject disclosure.

FIGS. 7 and 8 are graphical representations of simulated example unit cell reflection response showing reflection phase and magnitude, respectively, over frequency for varying values of ferroelectric permittivity for a first example varactor with a first set of permittivity values, in accordance with various example embodiments and implementations of the subject disclosure.

FIGS. 9 and 10 are graphical representations of simulated example unit cell reflection response showing reflection phase and magnitude, respectively, over frequency for varying values of ferroelectric permittivity for a first example varactor with a second set of permittivity values, in accordance with various example embodiments and implementations of the subject disclosure.

FIGS. 11 and 12 are graphical representations of simulated example unit cell reflection response showing reflection phase (FIG. 11) and reflection magnitude (FIG. 12) for varying values of ferroelectric permittivity for a second example varactor (different from the first example varactor of FIGS. 7-10), in accordance with various example embodiments and implementations of the subject disclosure.

### DETAILED DESCRIPTION

The technology described herein is generally directed towards an optically transparent metasurface including unit cells integrated with resonators having monolithically integrated ferroelectric devices coupled to metallic portions, e.g., in a ring shape such as a hexagon. In one implementation, the resonators are atop a fused-silica dielectric substrate that is optically transparent, which is above a ground plane with openings (punctures or perforations) referred to herein as a mesh, (as opposed to a solid metal surface as is typically used with metasurfaces). In one implementation, the mesh ground plane is characterized by circular openings arranged in a hexagonal/honeycomb pattern. In this implementation, the small size of the resonator, the optically transparent substrate and the mesh ground plane result in a metasurface that is substantially optically transparent.

In general, millimeter-wave (mm-wave) frequencies (including 28 GHz-110 GHz and higher) are to be used to achieve high data rates in next-generation wireless networks and beyond; however, these signals are easily disrupted by physical obstructions common in dense urban environments. To address this challenge, described herein is a metasurface capable of dynamic beamforming via ferroelectric varactors. One implementation is an optically transparent metasurface device designed to reflect mm-wave signals, such as redirecting them to otherwise dead-zones through windows, thus improving coverage in interior spaces.

Tunable capacitors (varactors) can be used for phase control of a metasurface's unit cells, facilitating beamforming. To make the unit cells dynamically configurable with respect to controllably and independently changing each unit cell's phase, as described herein at least one ferroelectric device (varactor diode, or simply varactor) is associated with each unit cell's resonating element. By controllably varying the capacitance via the varactor (or for example, a pair of varactors per unit cell), the respective individual phases of the respective unit cells are determined, whereby the resultant overall phase profile results in non-uniform phase variation to accomplish beamforming of a redirected instance of an incoming signal.

One implementation of the varactor phase control device is composed of Barium Strontium Titanate (BST) varactors (diodes), and in this example implementation, each unit cell has a pair (and can have up to four or more) such phase control devices. The ferroelectric-based varactor is designed with an extremely small aspect ratio to maintain significant optical transparency of the unit cell in general. The combination of the resonating element and its associated ferroelectric-based varactor diode(s), with the substantially optically transparent dielectric substrate and the mesh ground plane, results in a metasurface of unit cells that is highly optically transparent and can beamform redirected signals.

Highly suitable performance is demonstrated via simulated results of the unit cell, as well as with a device that can be fabricated and experimentally tested. Such a metasurface is thus useable for holographic applications, for example, as well as other applications.

It should be understood that any of the examples herein are non-limiting. Thus, any of the embodiments, aspects, concepts, structures, functionalities or examples described herein are non-limiting, and the technology may be used in various ways that provide benefits and advantages in communications and metasurfaces in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some practical limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

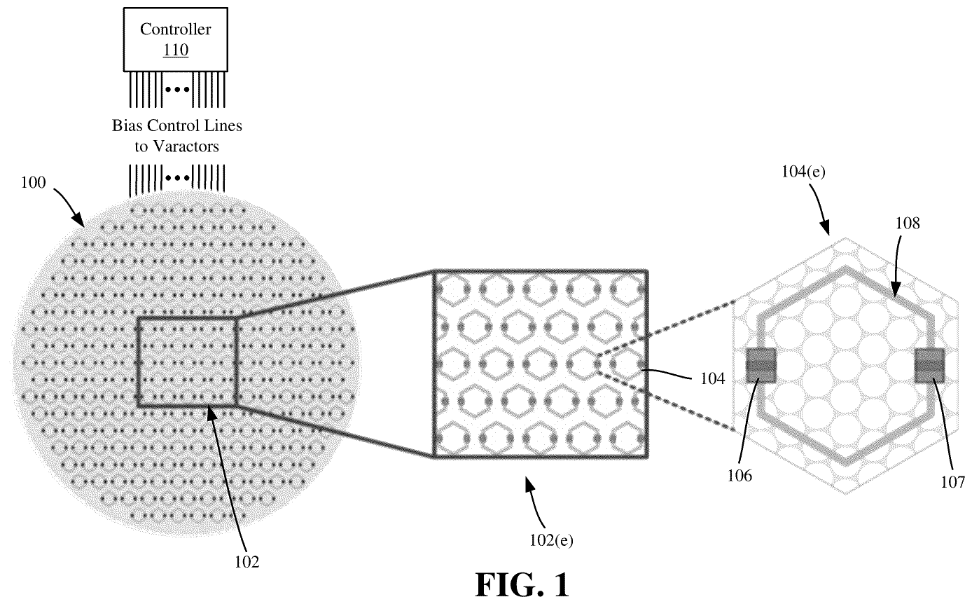

FIG. 1 shows a top view of a metasurface 100 configured as a unit cell array with BST varactor diodes. A portion 102 of the metasurface 100 is zoomed-in, in which the enlarged area 102(3) shows additional details. One of the unit cells 104 is zoomed-in; the enlarged view 104 shows two ferroelectric varactors 106 and 107 associated with the hexagonally-shaped resonating element 108.

The relative permittivity of ferroelectric thin films can be tuned via voltage biasing, thus being capable of operating as a varactor diode. Note that implementations of the metasurface have bias lines to provide the tuning voltage biases to the unit cells. FIG. 1 shows an example controller 110 that, as part of a system that includes the metasurface 100, can apply appropriate voltage to respective bias lines to independently apply voltage values to independently tune the respective varactors. The controller 110 can include a processor and memory, for example, with phase profile data (e.g., corresponding to voltage datasets) maintained in the memory and selected by the processor to reconfigure the metasurface to beamform a redirected signal on demand. Once tuned, the ferroelectric thin films (e.g., the BST varactors) are nonvolatile in that they retain their tuned permittivity after application and removal of the respective tuning voltages, whereby continuous power is not needed, but rather is only consumed during retuning of the metasurface.

BST thin film can be used because of ease of deposition on various substrates and low dielectric loss in the frequency band(s) of interest. BST (BaxSr1−xTiO3) is a perovskite and the stoichiometric ratio between Barium and Strontium can be tuned during fabrication, which is an additional degree of freedom for more precise control of the dielectric constant.

In one implementation, described herein is a unit cell capable of reflection phase tuning using BST ferroelectric thin film in the unit cell's resonator by varying the dielectric constant. As a result of the relatively minuscule size of the ferroelectric varactors, on the order of few hundred microns, and the narrow width of the metallic ring parts of the resonators, the metasurface is substantially optically transparent, which facilitates inconspicuous implementation on glass displays, windows or the like. For column by column (one-dimensional) beamforming, adding bias lines is straightforward and can be done on the same layer of the unit cell and strategically routed for minimum impact to performance.

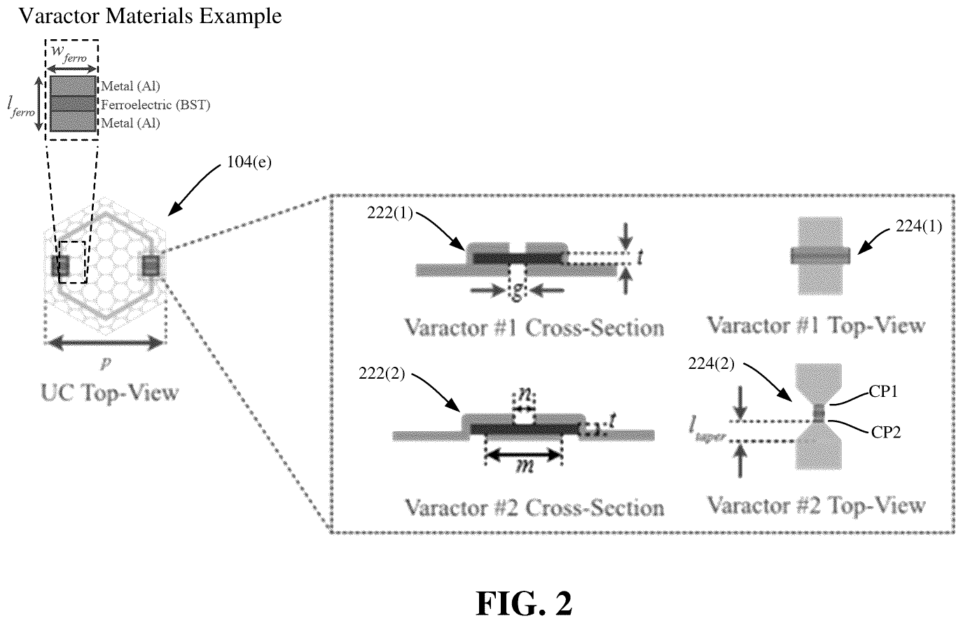

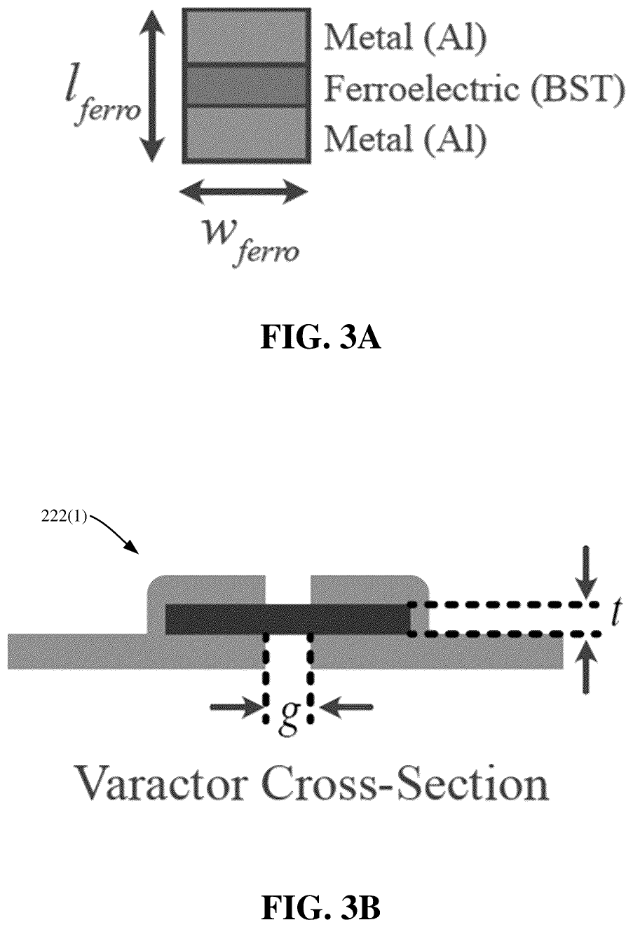

FIG. 2 shows the enlarged unit cell representation 104(e) and varactor dimensions (height and width of size p), along with two cross section views 222(1) and 222(2), and top views 224(1) and 224(2) for two example configurations #1 and #2 of BST varactors, respectively. Example materials are shown in FIG. 3A, with the ferroelectric (BST) located between aluminum (Al) layers. Due to the thin width of Varactor #2 224(2), the ring metallization is tapered (lₜₐₚₑᵣ is shown) to reduce reflection losses; at the two couplings CP1 and CP2 between the split parts of the metallic ring resonator of the metallic ring resonator, the metallic ring resonator narrows to correspond to the thin varactor dimensions.

As is depicted in this example, a pair of (e.g., BST) ferroelectric varactor elements are added to (e.g., inserted in gaps) between parts (e.g., two halves) of the hexagonal resonator. Note that only a single ferroelectric varactor element can be present, or more than two ferroelectric varactor elements can be present to form a resonator. For achieving high optical transparency of the metasurface in general, the BST varactor has an extremely small footprint, owing to its very high permittivity. Embodiments described herein include a perforated honeycomb-mesh ground plane and fused silica substrate, which also facilitate transparency. Once fabricated, this high transparency characteristic allows for seamless integration of the metasurface 100 (FIG. 1) on glass windows, panels, building facades and so on one, which is feasible to design as a metasurface/unit cell with appropriate performance.

In one implementation, the unit cell is hexagonal in shape, generally to maximize the number of unit cells when the array is fabricated on a circular wafer as in FIG. 1, such as used in cleanroom-based microfabrication processes. Notwithstanding, the technology is not limited to any particular shape of a metasurface, and for example an m unit cell by n unit cell rectangular surface can be instead fabricated. One implementation of an optically transparent unit cell configuration is designed to maintain a period of Λ<λ/2 at 28 GHz for sub-wavelength operation.

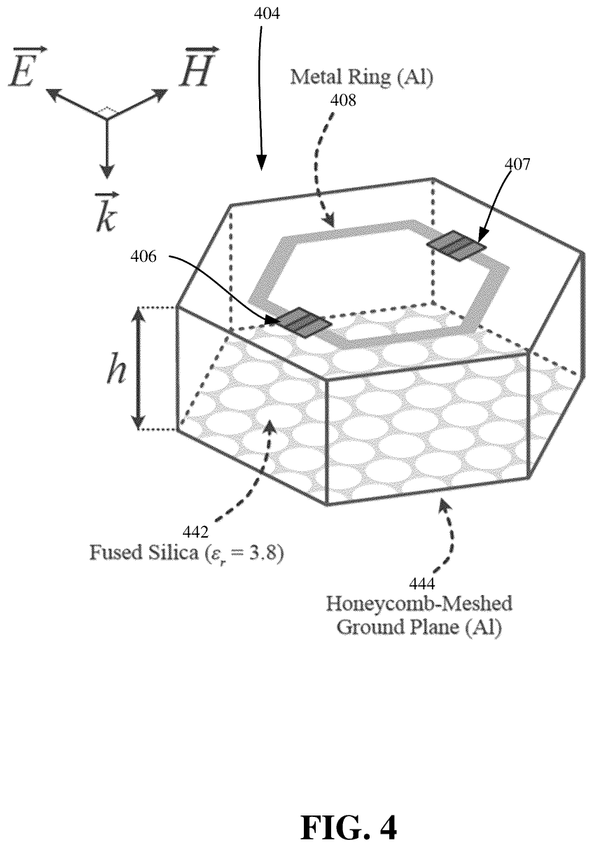

FIG. 4 is an isometric view of a unit cell 404 including varactors 406 and 407 associated with a metallic resonating element 408 in the form of a hexagonal ring resonator composed of aluminum. As can be seen in FIG. 4, the metallic resonating element 408 is fabricated on a substrate 442, which in this example is a fused silica substrate of h=0.5 mm. As illustrated in this example unit cell 404, the unit cell 404 has a hexagonal metal ring with a pair of symmetrical BST ferroelectric thin films varactors 406 and 407 added between the upper and lower halves of the ring resonator. The substrate 442 is above a honeycomb mesh ground plane 444, which is designed for high optical transparency.

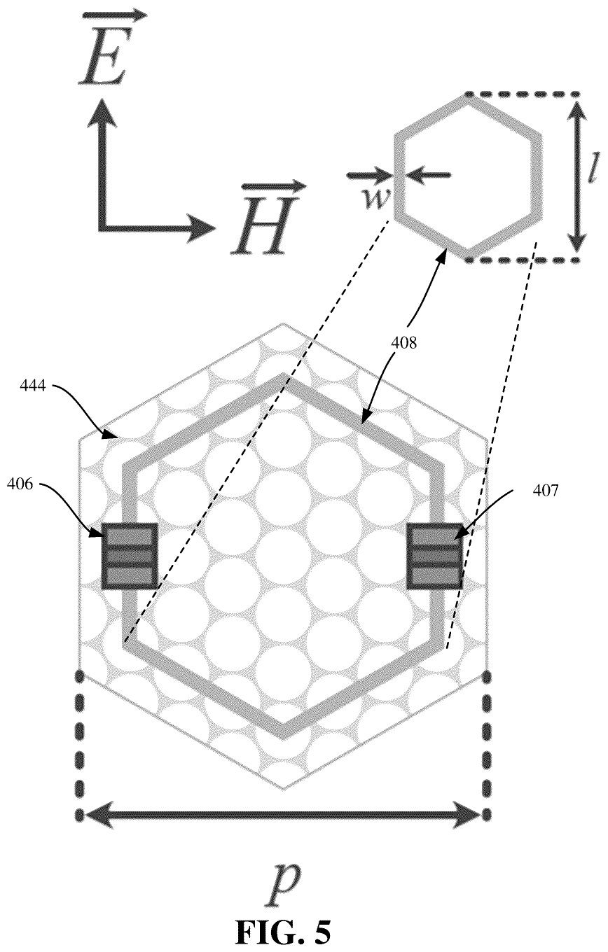

FIG. 5 shows a top view of one unit cell corresponding to the view of FIG. 3A and 3B, in which example materials of the BST varactor are identified, along with some of the dimensions. For example, the BST thin film can be 500 nm thick and sandwiched between the metal layers (aluminum). When a DC biasing voltage is applied through biasing lines (not explicitly shown) connected to the two halves of the ring, the electric-field confinement changes the permittivity of the BST thin film. This subsequently allows for phase tuning by changing the voltage bias, thereby acting as a tunable capacitor (or varactor).

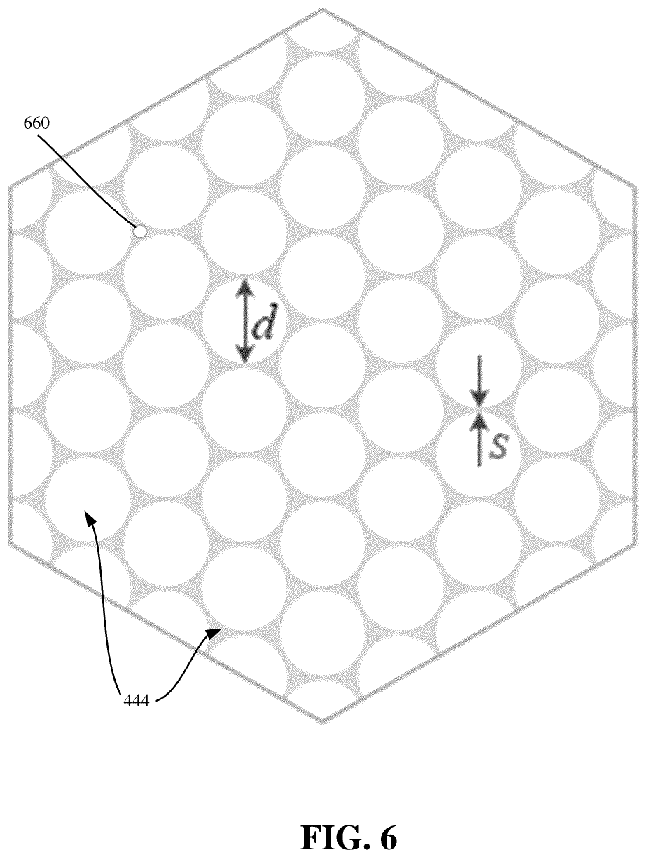

FIG. 6 shows the metallic ground plane 444 with perforations arranged in a honeycomb-like pattern, spaced, and distributed evenly. This makes the structure virtually fully reflective at mm-waves, but highly transparent at visible optical frequencies. In general, the honeycomb mesh ground plane 444 has large openings in the mesh's metal, which in this example are circular openings (punctures or perforations) as shown in FIG. 6. The openings have a diameter of d, separated by a separated distance s from one another. Also shown in FIG. 6 is an optional smaller perforation 660 between one grouping of (three) larger openings; (although not explicitly shown in FIG. 6, there can be similar smaller perforations between any or all such groupings of larger openings). The smaller perforations, if present in a given implementation, further increase transparency of the mesh ground plane, and thus increase the overall transparency of the metasurface.

Example dimensions are shown in FIGS. 2-6 (enlarged in FIG. 3B for the varactor #1). These various example unit cell dimensions/design parameters can be, in one example implementation, d=0.19 mm, s=2.7 mm; dielectric substrate thickness h=0.5 mm (fused silica is chosen because of low loss tangent and optical transparency and low permittivity ϵr=3.7¿3.8. Ring resonator dimensions in this example are w=0.1 mm, l=3 mm, and p=4.5 mm. Other example dimensions for those identified in FIGS. 2, 3A and 3B include l_{ferro} #1=0.15 millimeters (mm), l_{ferro} #2=0.1 mm, w_{ferro} #1=0.3 mm, w_{ferro} #2=2 microns (μm), g=10μm, n=10 μm, m=30 μm, lₜₐₚₑᵣ=30 μm, t=500 nanometers (nm).

Turning to experimental results, two different varactor configurations (corresponding to varactor number 1 (#1, 224(1) in FIG. 2) and varactor number 2 (#2, 224(2) in FIG. 2) were simulated; the frequency response of the unit cell varies based on the choice of varactor. Fabrication constraints were considered for the designs.

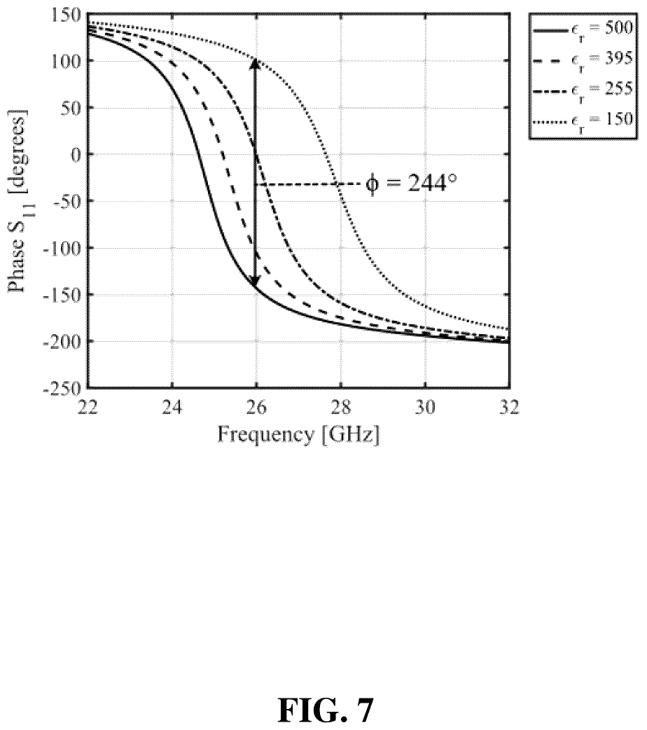

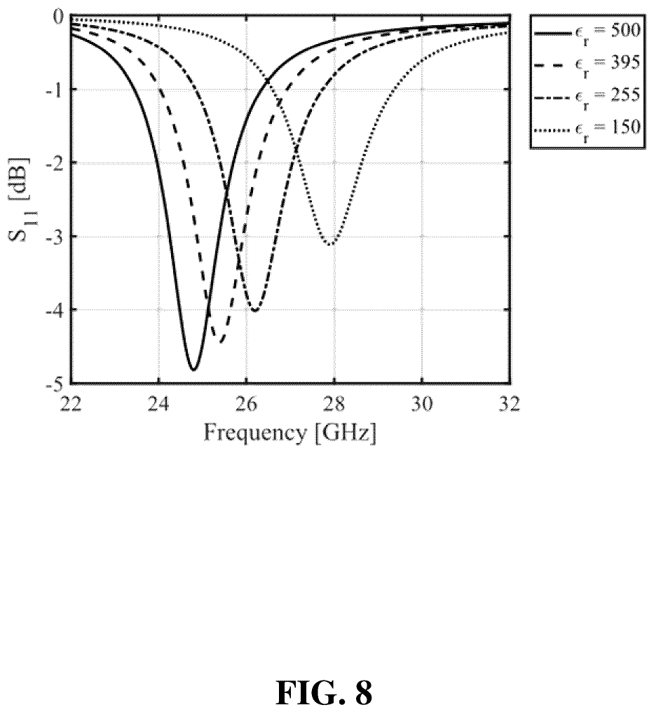

As described herein, the relative permittivity of the BST ferroelectric thin film layer can be controllable varied within reasonable values, such as from 150 to 500. The phase of the reflected electromagnetic waves is shown in FIG. 7 for the operating frequency range from 22-32 GHz of the hexagonal unit cell of FIG. 1 with ferroelectric Varactor #1 for different dielectric constant values of 150, 255, 395 and 500). The magnitude of the reflected electromagnetic waves is shown in FIG. 8 for the same operating frequency range from 22-32 GHz with the ferroelectric Varactor #1 for different dielectric constant values of 150, 255, 395 and 500.

The simulations performed that resulted in the reflection response shown in FIGS. 7 and 8 were performed in full-wave EM software Ansys-HFSS. Floquet ports are used for excitation under normal incidence to simulate an infinite periodic array with periodic boundary conditions. The E-field and H-field are shown in FIGS. 4 and 5, where the BST varactors are placed parallel to the E-field excitation. Voltage biasing (direct current) of the BST layer can be done via bias lines (FIG. 1) connecting the two halves of the hexagon ring resonator at the same potential, e.g., oriented orthogonal to the input E-field vectors.

Using lumped sheet simulations, a capacitor in the range of 0.01 pF to 0.1 pF in the frequency range of 20-30 GHz for appreciable phase swing was identified for the unit cell as an initial estimate of various varactor dimensions, which is essentially a parallel plate capacitor in this case. The dielectric constant and loss tangent of the BST (Ba_{0.6}Sr_{0.4}TiO₃) layer can vary between 500 to 150 and 0.047 to 0.03, respectively, in the simulations. This leads to the extremely small varactor area of only 150 m×300 m. The metal is modeled as aluminum with a finite conductivity. As desired and shown in FIGS. 7 and 8, a large phase tuning of about 244° is observed, with a down-shifting resonant frequency when the BST permittivity is increased (i.e., larger capacitance). The corresponding reflection loss increases with increasing BST permittivity or capacitance; for the entire range of permittivity sweep, the reflection loss |Γ| remains below 5 dB, which is considered suitable for practical use. These results confirm that the BST varactor integration in the unit cell with perforated ground plane, provide the appropriate phase control while featuring optically transparent characteristics using straightforward techniques.

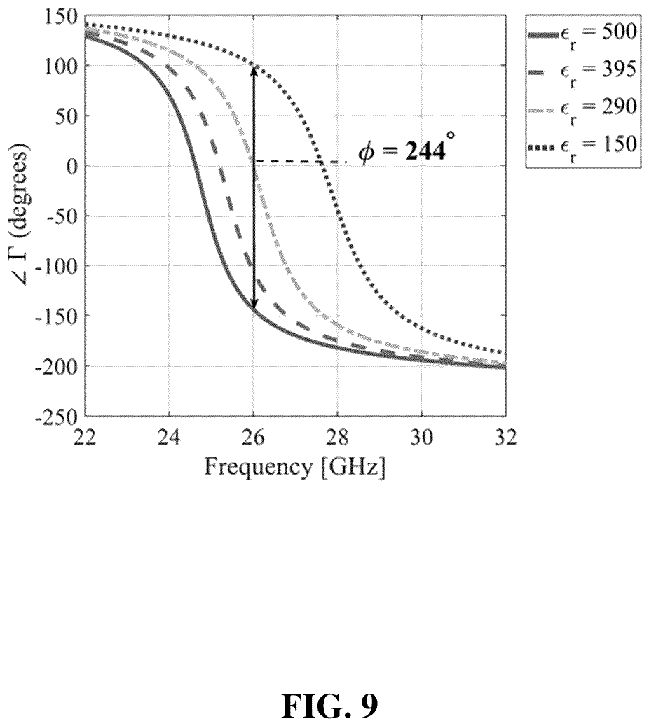

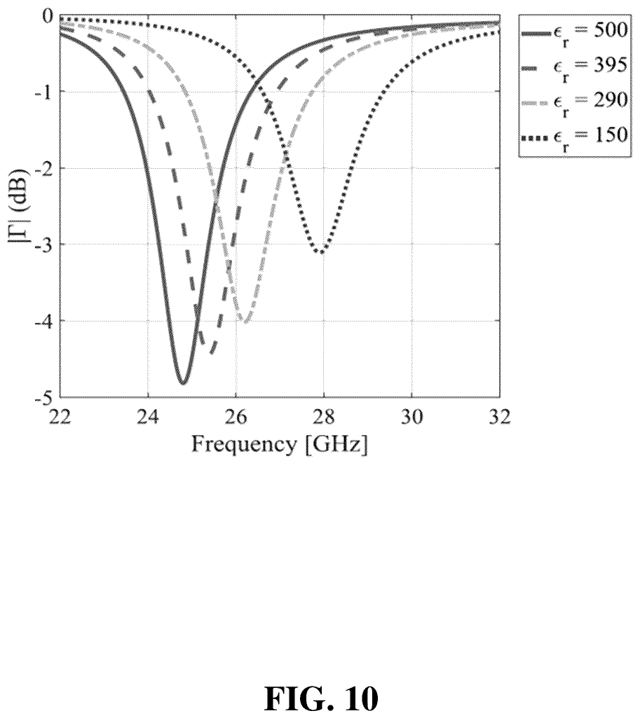

FIG. 9 are 10 are similar to FIGS. 7 and 8, respectively but show reflection response (phase and magnitude, respectively) with different dielectric constant values of 150, 290, 395 and 500. Note the dielectric constant value of 255 in FIGS. 7 and 8 versus 290 in in FIGS. 9 and 10.

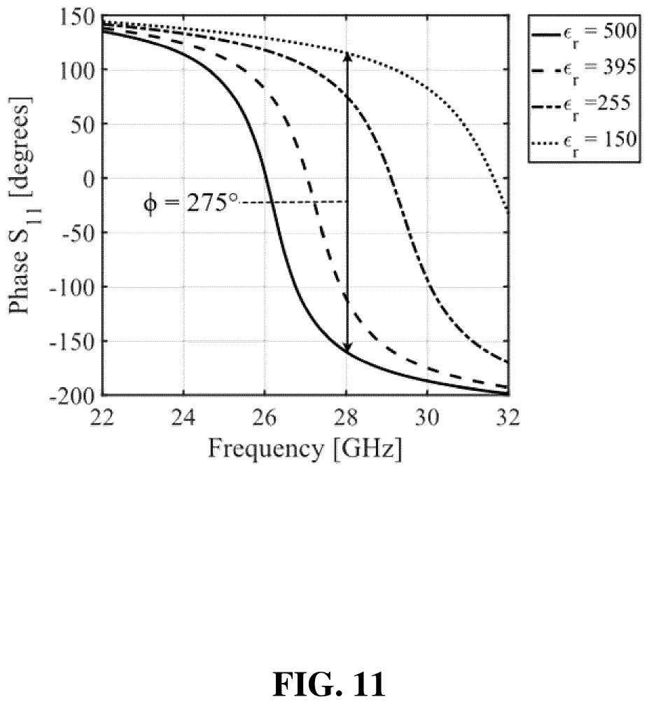

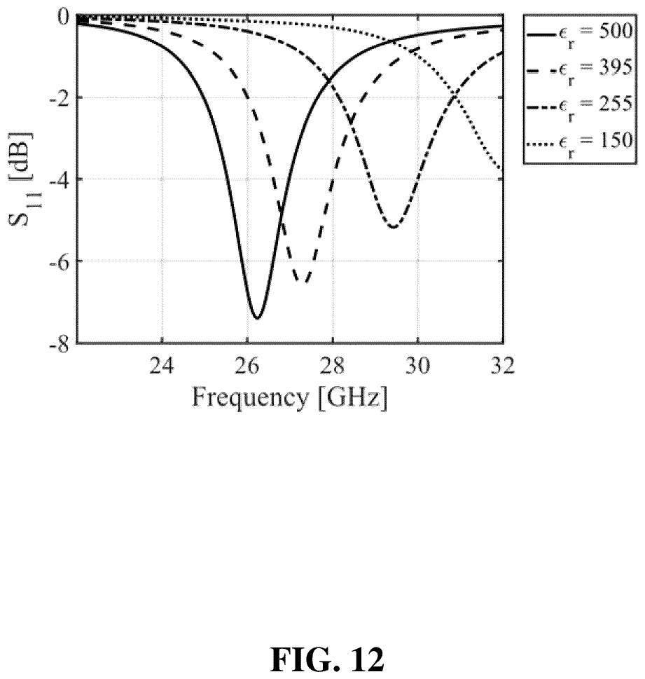

The different varactor configuration, namely Varactor number 2 (#2, 224(2) in FIG. 2), which is extremely small with a size of 100 μm×3 μm, was also simulated. FIGS. 11 and 12 show the reflection response (phase and magnitude, respectively) of varactor number 2 for the different dielectric constant values of 150, 255, 395 and 500. As can be seen in FIG. 11, the frequency response has a phase range of around 275 degrees at 28 GHz, and the reflection magnitude is below −7.5 dB.

Note that for Varactor #1 as shown in in FIGS. 9 and 10 with these dielectric constant values, the reflection magnitude is below −5 dB and the phase range of around 244 degrees at 26 GHz. However, in contrast to Varactor #2, the varactor size of Varactor #1 is 150 m by 300 m which will reduce optical transparency. Indeed, a phase range of about 250° is achieved with the first varactor configuration #1, and 275° with the varactor configuration #2, which are adequate ranges to design a metasurface/reflectarray. Varactor #2 has an extremely small aspect ratio of 100 m by 3 m, which is advantageous for optical transparency and has a higher phase range. Varactor #2 has marginally higher loss as compared to Varactor #1, which has a bigger footprint of 150 m by 300 m.

Thus, there is a tradeoff for higher optical transparency. The geometric parameters (p, w, l) of a unit cell and dimensions of the ferroelectric varactor (l_{ferro}, w_{ferro}, t, g, m, n) can be optimized for maximum phase range with minimum possible reflection magnitude; different metasurfaces can be designed for various applications based on a desired amount of transparency versus reflection magnitude.

One or more implementations can be embodied in a device, such as described in the example embodiments and implementations included herein. The device can include a metallic resonating element, a phase control device coupled to the metallic resonating element, the phase control device including ferroelectric material that changes a permittivity based on an applied voltage, and a portion of a mesh ground plane beneath the metallic resonating element and the phase control device. The metallic ring resonator, the phase control device, and the portion of the mesh ground plane can form a substantially optically transparent unit cell. The permittivity of the ferroelectric material is controllably variable, when varied, to result in a corresponding phase response of the unit cell.

The device further can include an optically transparent, or substantially optically transparent, substrate between the metallic resonating element and the mesh ground plane.

The ferroelectric material can include Barium Strontium Titanate material.

The phase control device can include a pair of varactor diodes.

The metallic resonating element can include a first part and a second part, a first varactor diode of the pair of varactor diodes can be coupled between the part and the second part on a first side of the metallic resonating element, and a second varactor diode of the pair of varactor diodes can be coupled between the first part and the second part on a second side of the metallic resonating element.

The first part of the metallic resonating element on the first side can be tapered at a first coupling to a first end of the first varactor diode, the second part of the metallic resonating element on the first side can be tapered at a second coupling to a second end of the first varactor diode, the first part of the metallic resonating element on the second side can be tapered at a third coupling to a third end of the second varactor diode, and the second part of the metallic resonating element on the second side can be tapered at a fourth coupling to a fourth end of the second varactor diode.

The metallic resonating element can include a ring resonator.

The metallic resonating element can include a hexagonally-shaped ring resonator.

The substantially optically transparent unit cell can be part of a honeycomb lattice of unit cells.

The substantially optically transparent unit cell can be part of a metasurface of unit cells.

The metasurface can be a holographic metasurface.

The substantially optically transparent unit cell can be a first unit cell of respective unit cells configured as a metasurface, wherein the respective unit cells have respective controllably variable phase responses, and the respective variable phase responses can be controlled to result in a phase profile of the metasurface that redirects a signal impinging on the metasurface as a redirected beamformed instance of the signal.

One or more implementations can be embodied in a metasurface, such as described in the example embodiments and implementations included herein. The metasurface can include a substrate, and respective unit cells above the substrate. The respective unit cells can include respective resonators having respective variable phases, and the respective resonators can include respective metal ring sets and respective voltage-controllable ferroelectric material varactor sets. The metasurface can include a mesh ground plane beneath the substrate; the mesh ground plane The metasurface can include openings that can be optically transparent or substantially optically transparent. The metasurface can be a substantially optically transparent metasurface based on the substrate being transparent or substantially optically transparent, the mesh ground plane being transparent or substantially optically transparent, and dimensions of the respective resonators.

The substrate can include fused silica, and wherein the ferroelectric material varactor sets can include Barium Strontium Titanate material.

The respective voltage-controlled ferroelectric material varactor sets can be independently controlled to determine a phase profile that redirects a signal impinging on the metasurface as a redirected beamformed instance of the signal.

The respective voltage-controlled ferroelectric material varactor sets can be independently controlled in a first operation to determine a first phase profile, the signal impinging on the metasurface can be a first signal, the redirected beamformed instance can be a first redirected beamformed instance, the first redirected beamformed instance of the signal can have a first direction, the respective voltage-controlled ferroelectric material varactor sets can be independently controlled in a second operation to determine a second phase profile that redirects a second signal impinging on the metasurface as a second redirected beamformed instance of the signal, and the second redirected beamformed instance of the signal can have a second direction that can be different from the first direction.

The respective voltage-controlled ferroelectric material varactor sets can be independently controlled in a first operation to determine a first phase profile, the signal impinging on the metasurface can be a first signal, the redirected beamformed instance can be a first redirected beamformed instance, the first redirected beamformed instance of the signal can have a first directivity, the respective voltage-controlled ferroelectric material varactor sets can be independently controlled in a second operation to determine a second phase profile that redirects a second signal impinging on the metasurface as a second redirected beamformed instance of the signal, and the second redirected beamformed instance of the signal can have a second directivity that can be different from the first directivity.

One or more implementations can be embodied in a unit cell, such as described in the example embodiments and implementations included herein. The unit cell can include a resonating element, the resonating element including a ring resonator comprising at least two metallic parts divided by, and coupled to, at least one ferroelectric-based varactor set having variable permittivity. The unit cell can include an optically transparent, or substantially optically transparent, substrate beneath the resonating element, and a metal mesh structure corresponding to a ground plane beneath the substrate, the metal mesh structure including optically transparent openings. In response to an electromagnetic wave impinging on the unit cell at a frequency that resonates the resonating element, the unit cell redirects an instance of the electromagnetic wave based on a reflection response determined by the variable permittivity of the at least one ferroelectric-based varactor set.

The at least two metallic parts, in conjunction with the at least one ferroelectric-based varactor set, can include a hexagonally-shaped ring resonator.

The at least two metallic parts can be tapered to couple to the at least one ferroelectric-based varactor set.

As can be seen, described herein is a tunable metasurface of unit cells with resonators including metallic parts and monolithically integrated ferroelectric devices. In one implementation, an optically transparent (or substantially operatically transparent) substrate and substantially operatically transparent mesh ground plate results in a substantially operatically transparent metasurface, which, for example, can be used as a holographic metasurface suitable for holographic applications.

The ferroelectric device is tunable to make the unit cells'reflection responses dynamically reconfigurable, facilitating for non-uniform phase variation to result in beamforming. The ferroelectric material can be composed of BST material.

In addition to holographic applications, usage examples include smart windows; optically transparent reflective metasurfaces can be integrated into glass panels to redirect mm-wave (or higher frequency) signals around obstacles like furniture or columns, ensuring consistent high-speed wireless connectivity in offices. The transparency of the metasurface preserves the windows'aesthetic appeal and allows natural light to enter, maintaining a bright, open environment.

Transparent displays with beamforming capabilities are also facilitated; for example, transparent displays used for digital signage in retail settings can incorporate optically transparent reflective metasurfaces to function as beamforming devices. This enables them to direct mm-wave signals to specific areas, enhancing wireless connectivity for customers while remaining invisible and ensuring the display content is unaffected.

Urban infrastructure enhancements are feasible; in urban areas, reflective metasurfaces can be added to bus shelters, light poles, or streetlamps to improve wireless signal coverage in areas with poor reception, such as narrow streets or congested zones. Such metasurfaces enhance connectivity without obstructing visibility or altering the infrastructure's appearance.

Advanced automotive applications can leverage transparent reflective metasurfaces embedded in panoramic vehicle roofs to redirect mm-wave signals within the car, providing reliable connectivity for the passengers even in weak signal areas. The transparency of the metasurface maintains the roof's design and unobstructed views.

To summarize, tunable capacitors (varactors) are used as described herein based on the tunable relative permittivity of ferroelectric thin films via voltage biasing (tuned in their paraelectric phase above the Curie temperature), facilitating beamforming in a metasurface unit cells, allowing beamforming. Moreover, due to the relatively minuscule size of the ferroelectric varactor in the order of few hundred microns, based on thin metal parts and bias lines, a transparent substrate, and a mesh ground plane, the metasurface can be significantly optically transparent, which facilitates inconspicuous implementation on glass displays.

To reiterate, implementations and embodiments of the technology described herein are generally directed towards an optically transparent active reflectarray metasurface, such as for use in the 5G mm-Wave band of around 28 GHz based on specially designed varactor diodes using barium strontium titanate (BST) thin films for phase control applications. By varying the voltage bias of the BST thin film, the dielectric constant, and hence capacitance, can be changed, thus allowing phase response manipulation. Simultaneously, one or more implementations of the design are based on a perforated honeycomb mesh as a ground plane on a fused silica substrate for achieving a high degree of optical transparency.

The technology described herein includes ferroelectric materials to be used as varactor diodes for beam-steering metasurface applications, e.g., in the 5G mm-Wave regime using full-wave simulations. The unit cell performance has been demonstrated using full-wave simulations as described herein. By varying the relative permittivity of the BST layer, a reflection phase variation of about 244 degrees has been achieved at 26 GHz with acceptable reflection losses. These results confirm the use of ferroelectric materials and specifically BST in 5G mm-Wave communication systems based on smart metasurfaces. Furthermore, ferroelectric materials can be monolithically integrated into metasurface unit cells using microfabrication cleanroom processes, which facilitate highly feasible, future large-scale production with fine dimensional accuracies. The high optical transparency of the unit cell design with a thin form factor may, for example, find use in holography, and in smart windows where they can be integrated in glass panels to redirect mm-wave signals around obstacles like furniture or columns, ensuring consistent connectivity in homes and offices while preserving the aesthetics.

What has been described above include mere examples. It is, of course, not possible to describe every conceivable combination of components, materials or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
a metallic resonating element;
a phase control device coupled to the metallic resonating element, the phase control device comprising ferroelectric material that changes a permittivity based on an applied voltage; and
a portion of a mesh ground plane beneath the metallic resonating element and the phase control device,
wherein the metallic ring resonator, the phase control device, and the portion of the mesh ground plane form a substantially optically transparent unit cell, and
wherein the permittivity of the ferroelectric material is controllably variable, when varied, to result in a corresponding phase response of the unit cell.

2. The device of claim 1, further comprising:
an optically transparent, or substantially optically transparent, substrate between the metallic resonating element and the mesh ground plane.

3. The device of claim 1, wherein the ferroelectric material comprises Barium Strontium Titanate material.

4. The device of claim 1, wherein the phase control device comprises a pair of varactor diodes.

5. The device of claim 4, wherein the metallic resonating element comprises a first part and a second part, wherein a first varactor diode of the pair of varactor diodes is coupled between the part and the second part on a first side of the metallic resonating element, and wherein a second varactor diode of the pair of varactor diodes is coupled between the first part and the second part on a second side of the metallic resonating element.

6. The device of claim 5, wherein the first part of the metallic resonating element on the first side is tapered at a first coupling to a first end of the first varactor diode, wherein the second part of the metallic resonating element on the first side is tapered at a second coupling to a second end of the first varactor diode, wherein the first part of the metallic resonating element on the second side is tapered at a third coupling to a third end of the second varactor diode, and wherein the second part of the metallic resonating element on the second side is tapered at a fourth coupling to a fourth end of the second varactor diode.

7. The device of claim 1, wherein the metallic resonating element comprises a ring resonator.

8. The device of claim 1, wherein the metallic resonating element comprises a hexagonally-shaped ring resonator.

9. The device of claim 1, wherein the substantially optically transparent unit cell is part of a honeycomb lattice of unit cells.

10. The device of claim 1, wherein the substantially optically transparent unit cell is part of a metasurface of unit cells.

11. The device of claim 1, wherein the metasurface is a holographic metasurface.

12. The device of claim 1, wherein the substantially optically transparent unit cell is a first unit cell of respective unit cells configured as a metasurface, wherein the respective unit cells have respective controllably variable phase responses, and wherein the respective variable phase responses are controlled to result in a phase profile of the metasurface that redirects a signal impinging on the metasurface as a redirected beamformed instance of the signal.

13. A metasurface, comprising:
a substrate;
respective unit cells above the substrate, the respective unit cells comprising respective resonators having respective variable phases, the respective resonators comprising respective metal ring sets and respective voltage-controllable ferroelectric material varactor sets; and
a mesh ground plane beneath the substrate, the mesh ground plane comprising openings that are optically transparent or substantially optically transparent,
wherein the metasurface is a substantially optically transparent metasurface based on the substrate being transparent or substantially optically transparent, the mesh ground plane being transparent or substantially optically transparent, and dimensions of the respective resonators.

14. The metasurface of claim 13, wherein the substrate comprises fused silica, and wherein the ferroelectric material varactor sets comprise Barium Strontium Titanate material.

15. The metasurface of claim 13, wherein the respective voltage-controlled ferroelectric material varactor sets are independently controlled to determine a phase profile that redirects a signal impinging on the metasurface as a redirected beamformed instance of the signal.

16. The metasurface of claim 15, wherein the respective voltage-controlled ferroelectric material varactor sets are independently controlled in a first operation to determine a first phase profile, wherein the signal impinging on the metasurface is a first signal, wherein the redirected beamformed instance is a first redirected beamformed instance, wherein the first redirected beamformed instance of the signal has a first direction, wherein the respective voltage-controlled ferroelectric material varactor sets are independently controlled in a second operation to determine a second phase profile that redirects a second signal impinging on the metasurface as a second redirected beamformed instance of the signal, and wherein the second redirected beamformed instance of the signal has a second direction that is different from the first direction.

17. The metasurface of claim 15, wherein the respective voltage-controlled ferroelectric material varactor sets are independently controlled in a first operation to determine a first phase profile, wherein the signal impinging on the metasurface is a first signal, wherein the redirected beamformed instance is a first redirected beamformed instance, wherein the first redirected beamformed instance of the signal has a first directivity, wherein the respective voltage-controlled ferroelectric material varactor sets are independently controlled in a second operation to determine a second phase profile that redirects a second signal impinging on the metasurface as a second redirected beamformed instance of the signal, and wherein the second redirected beamformed instance of the signal has a second directivity that is different from the first directivity.

18. A unit cell, comprising:
a resonating element, the resonating element comprising a ring resonator comprising at least two metallic parts divided by, and coupled to, at least one ferroelectric-based varactor set having variable permittivity;
an optically transparent, or substantially optically transparent, substrate beneath the resonating element; and
a metal mesh structure corresponding to a ground plane beneath the substrate, the metal mesh structure comprising optically transparent openings,
wherein, in response to an electromagnetic wave impinging on the unit cell at a frequency that resonates the resonating element, the unit cell redirects an instance of the electromagnetic wave based on a reflection response determined by the variable permittivity of the at least one ferroelectric-based varactor set.

19. The unit cell of claim 17, wherein the at least two metallic parts, in conjunction with the at least one ferroelectric-based varactor set, comprise a hexagonally-shaped ring resonator.

20. The unit cell of claim 17, wherein the at least two metallic parts are tapered to couple to the at least one ferroelectric-based varactor set.
